(19) United States
(12) Patent Application Publication
(10) Pub. No.: US 2010/0073954 A1
(43) Pub. Date: Mar. 25, 2010

(54) Lamp for Motor Vehicles

(75) Inventor: Matthias Gebauer, Reutlingen (DE)

Correspondence Address: CENTRAL COAST PATENT AGENCY, INC, 3 HANGAR WAY SUITE D, WATSONVILLE, CA, 95076, US

(73) Assignee: AUTOMOTIVE LIGHTING REUTLINGEN GMBH, Reutlingen (DE)

(21) Appl. No.: 12/559,777

(22) Filed: Sep. 15, 2009

(30) Foreign Application Priority Data
Sep. 25, 2008 (DE) 10 2008 048 751.1

(51) Int. Cl. B60Q 1/00; F21V 8/00; B60Q 1/04

(52) U.S. Cl. 362/551; 362/511; 362/507

(57) ABSTRACT

A lamp for a motor vehicle having at least one light source (50, 51, 53) and at least one planar optical waveguide (10) with at least two optical waveguide surfaces (14, 16) and at least one peripheral surface (12) into which the light of the light source (50, 51, 53) can be coupled directly or indirectly, and a light decoupling surface (14) that is formed by one of the optical waveguide surfaces, first decoupling elements (18) being provided on the optical waveguide surface (16) opposite the light decoupling surface (14), wherein at least one rod-like optical waveguide (20) is provided which is connected directly to the planar optical waveguide (10) or is part of the planar optical waveguide (10), the rod-like optical waveguide (20) having a decoupling surface (30) that decouples substantially into or against a driving direction of the motor vehicle and the light decoupling direction of the planar optical waveguide (10) is substantially perpendicular to at least one of its optical waveguide surfaces, and it being possible for the light of a light source (50, 51, 53) to be coupled directly or indirectly into the rod-like optical waveguide (20), and the rod-like optical waveguide (20) having second light decoupling elements (22) that are arranged on that side (28) of the rod-like optical waveguide (20) that is opposite the decoupling surface (30).

### CROSS-REFERENCE TO RELATED DOCUMENTS

The present application claims priority to German patent application serial number 10 2008 048 751.1, which was filed on Sep. 25, 2008, which is incorporated herein in its entirety, at least by reference.

### DESCRIPTION

The invention relates to a lamp for motor vehicles having at least one light source and at least one planar optical waveguide with at least two optical waveguide surfaces and at least one peripheral surface into which the light of the light source can be coupled directly or indirectly, and a light decoupling surface that is formed by one of the optical waveguide surfaces, first decoupling elements being provided on the optical waveguide surface opposite the light decoupling surface.

Such lamp arrangements are known in the prior art and described, for example, in US 2004/0136203 A1, which describes an optical waveguide having a plurality of decoupling elements for producing a light distribution which does not comply with a statutory lamp function, but which produces a diffuse light such that the light beams are emitted in the various directions.

Moreover, an appropriate arrangement with a planar optical waveguide is previously known from DE 102 00 359 A2, in the case of which a planar optical waveguide is arranged in front of a further lamp. The point here is that in Europe a headlamp may emit only light which is associated with a function. That is to say, pure design lamps which have no lighting function are not permissible. Moreover, it is to be ensured that white light may be emitted rearward only up to a very low maximum value, and red light may be emitted rearward forward only up to a very low maximum value.

Starting from this prior art, the invention now sets the object of providing an alternative lamp which also provides a lighting function in addition to an ambient illumination in the form of a light curtain such as is described in US 2004/0136203 A1.

The invention achieves this object by a lamp having the features of claim 1, specifically a lamp for motor vehicles having at least one light source, for example, of one or more incandescent lamps or LEDs and at least one planar optical waveguide with at least two optical waveguide surfaces and at least one peripheral surface, into which the light of the light source can be coupled directly or indirectly, and a light decoupling surface that is formed by one of the optical waveguide surfaces, first decoupling elements being provided on the optical waveguide surface opposite the light decoupling surface, and the lamp comprising at least one rod-like optical waveguide which is connected directly to the planar optical waveguide or is part of the planar optical waveguide, the rod-like optical waveguide having a decoupling surface that decouples light substantially in or against a driving direction of the motor vehicle, and the planar optical waveguide decoupling light substantially perpendicular to its light decoupling surface and/or the opposite optical waveguide surface, and it being possible for the light of a light source to be coupled directly or indirectly into the rod-like optical waveguide, and it having second decoupling elements which are arranged on the side, opposite the decoupling surface of the rod-like optical waveguide, of the rod-like optical waveguide. In particular, in this case the planar optical waveguide can emit light only together with the rod-like optical waveguide. The lamp can be used as a module inside a headlamp or a taillamp, or be integrated in a terminating lens.

According to a first refinement, it can be provided that the dimensions of the first decoupling elements are such that the incident light is scattered such that no statutory light function is fulfilled by the planar optical waveguide, and the second decoupling elements are dimensioned such that the incident light is scattered and decoupled such that a statutory light function is fulfilled. The second decoupling elements are in this case larger than the first, that is to say they have a larger base surface or largest extent and/or a greater height in the light emission direction. This results in the advantage that, on the one hand, a lighting function, for example a light function, and, at the same time, a design element can be provided, by means of which, for example, the vehicle contour is to be illuminated. Here, the lighting requirements are largely fulfilled by the rod-like optical waveguide, while the planar optical waveguide, which can also be denoted as a light curtain, supports the lighting requirements to a small extent, for example visibility, and operates at the same time as a design element with said conditions that substantially no white light may be emitted rearward and no red light may be emitted forward. It can be provided in this case that, in order to accentuate the contour of the vehicle, the planar optical waveguide is designed as a free form surface, flat surfaces also being of interest. The rod-like optical waveguide can likewise be of curved design.

In order, for example, to position light in the case of which a tube of the headlamp is designed as a luminous surface, the rod-like optical waveguide may be formed only on one side of the optical waveguide.

Various optical impressions can be obtained by the use of two decoupling elements of different size which are formed by recesses or projecting structures on a side, opposite the light decoupling surface, of the optical waveguides. Thus, by providing comparatively small decoupling elements or structures it is possible to produce a homogeneously luminous surface and, moreover, provision of a rod-like optical waveguide can provide a light function such as, for example, a side light. Together with the homogeneously luminous surface, which forms a type of light curtain, it is possible to create special optical effects. Thus, such lamp arrangements can, moreover, be combined with further lamps which, for example, consist of a reflector, a combination of a reflector and lens, the light curtain also being able to form the lens of another light function, or else a further optical waveguide and the corresponding light sources, it being possible by way of example to provide a further light function in an annularly arranged side light, whereas the tube of the further light function can be designed as a homogeneously luminous surface or light curtain, for example, as a so-called side marker. In this case, the light curtain would not be completely surrounded by the rod-like optical waveguide and the rod-like optical waveguide would have regions on which no light curtain or planar optical waveguide is formed. The light curtain produces an ambient illumination but can contribute to the overall visibility of the lamp and, finally, of the vehicle.

Thus, it can be provided, in particular, that the first light decoupling elements have a greatest extent in the plane direction of the decoupling surfaces of <5 mm, in particular <1 mm and in particular <0.5 mm.

It can, furthermore, be provided that the second light decoupling elements have a greatest extent in the plane direction of >0.5 mm, in particular of >1 mm, and in particular of >5 mm. These larger light decoupling elements can have the effect that the decoupled light serves to attain a light function which corresponds to the statutory requirements, or that a detectable contour illumination is formed.

The first and second decoupling elements can be designed either as recesses in the planar optical waveguide, or else as elevations, it being possible for the shape of the decoupling elements both to be conical and to be like a conical frustum, like a pyramid, like a spherical cap or prismatic, as well as like a roof or like a ship's hull.

Depending on configuration, it is advantageous when the decoupling elements attain a homogeneous or defined light distribution. A defined distribution can be achieved, in particular, when use is made, instead of cones or hemispheres, of decoupling elements with uncurved lateral surfaces which are capable of deflecting the light in a direction in a defined fashion. Decoupling elements with uncurved surfaces have the advantage that light which strikes a surface is in any case deflected in the same direction, this not being so with curved surfaces, since with a sphere or a hemisphere each point of the sphere deflects the light to another point, and in the case of a cone the same deflection occurs only along a line which connects the base to the vertex of the cone.

It can be advantageous in this case when the plane surfaces are aligned in relation to the propagation direction of the light to ensure decoupling in as homogeneous, targeted and efficient a fashion as possible. By virtue of the fact that the light direction of the incident light is substantially known at each decoupling element, the decoupling elements can then be correspondingly positioned such that the prisms can decouple in specific directions. Substantially higher decoupling efficiency in a specific direction can thereby be achieved, since the proportion of the light which is scattered to the side and decoupled without intention can be kept low. It is possible in principle in this case to proceed in an idealized fashion from a radial alignment in the case of punctiform light sources and, in the case of linear light sources, from a linear alignment which is associated with the light propagation direction in the planar optical waveguide. It is possible, in particular, to provide in this case that the non-rotationally symmetrical decoupling elements project into the planar optical waveguide or project out therefrom.

If the decoupling elements have a pyramidal shape, an angle of inclination of 20°-60°, in particular of 40°-50°, to the base surface can be provided. If a pyramidal shape is provided, an angle of inclination likewise of 20°-60° and, in particular, of 40°-50° to the base surface can be provided, and in the case of the provision of roof-shaped decoupling elements a likewise arranged angle of inclination of 20°-60° and, in particular, of 40°-50° can be provided. In the case of roof-shaped decoupling elements it is possible in this case to provide an aspect ratio of 1:1-1:10, in particular of 1:2-1:4.

It is likewise possible to provide shapes like a ship's hull having an angle of inclination to the base surface of 20°-60° and, in particular, of 40°-50°.

A particularly homogeneous illumination can be achieved by means of an appropriate selection and configuration of the first and second decoupling elements.

In this case, the second light decoupling elements can be, in particular, prisms or else other planar decoupling elements, such as, for example, decoupling elements shaped like a roof or a pyramid, the decoupling elements being arranged with at least one of their surfaces transverse to the longitudinal extent of the rod-like optical waveguide, in particular. According to a further alternative refinement, it can be provided that the light decoupling element extends with at least one of its surfaces parallel to the longitudinal extent of the rod-like optical waveguide. In this case, it is possible in practice to provide a single light decoupling element which extends over the entire length of the rod-like optical waveguide, it also being possible to provide that a plurality of prisms extending in a longitudinal direction or, in general, decoupling elements are provided which are arranged at a spacing from one another.

In addition to the abovementioned decoupling elements, it is also possible for the purpose of forming the first decoupling elements to use ones which are provided by a surface roughness in the planar optical waveguide. The light can be scattered diffusely in various directions at such rough surfaces.

It is particularly advantageous to provide that the rod-like optical waveguide extends over at least a portion of the periphery of the planar optical waveguide. Alternatively, or in addition, the rod-like optical waveguide can be arranged in a planar optical waveguide. In this case, the planar optical waveguide can extend only over a portion of the rod-like optical waveguide. It follows that both are therefore possible, provided specifically that the rod-like optical waveguide extends only over a portion of the planar optical waveguide, and also that the planar optical waveguide extends only over a portion of the rod-like optical waveguide. Both the rod-like optical waveguide and the planar optical waveguide can be of straight, that is to say, plane or curved design. The rod-like optical waveguide can in this case be formed with any desired curvature or in a straight fashion, the curvatures being capable of following specific contours in the motor vehicle or contours of further light function elements in a headlamp.

It is possible, furthermore, in this case to provide that the two optical waveguides are interconnected in one piece or by integral bonding, as a result of which it is possible, if desired, to have a particularly good transmission of light between the optical waveguides. The optical waveguides can have a common light source, and the light can be launched from one optical waveguide into the second optical waveguide. However, it is also conceivable in principle for the optical waveguides to be supplied with light by various light sources, or it is also possible to provide a plurality of light sources per optical waveguide.

Finally, it is possible to provide as further optical element that the rod-like optical waveguide has a greater extent in the light emission direction than the planar. In other words, it can be said that the rod-like optical waveguide has a greater thickness than the planar optical waveguide, as a result of which it is possible to create a further optical design element and, moreover, there is no problem in arranging the relatively large light decoupling elements in the rod-like optical waveguide.

The light coupling surfaces can in this case be one or more sections of the peripheral surface of the planar optical waveguide.

If the rod-like optical waveguide cooperates with a dedicated light source, it is possible to provide that the light is coupled at one of the end faces of the rod-like optical waveguide.

Finally, it can be provided according to the invention that, in a fashion similar to the case of DE 102 00 359 A1, there is arranged behind the planar optical waveguide a further lamp which transirradiates the planar optical waveguide if light is applied to this lamp.

With a given number of decoupling elements, and knowing the geometry of the latter, the light flux must can be appropriately selected in order to achieve as high as possible a decoupling efficiency with a planar optical waveguide which forms a light curtain. There are in this case a series of parameters that have an influence on the efficiency of the overall system:
shape, size and number of the decoupling elements;
thickness, length, width and shape of the optical waveguide;
light flux and type of light source.

In this case, a specific number of said parameters are generally prescribed, and the rest can be freely selected, for the design of a lamp arrangement. The goal here is to select the free parameters such that enough light flux is present in order to fulfill the desired function or ambient illumination, but not too much, in order not to exceed the upper limit of the function and to minimize the costs of the light source.

The aim below is to explain how an optimum relationship can be produced between the abovementioned parameters such that it is possible for the unknown parameters to be derived and determined easily from the known ones, and thus to achieve an optimum function by a light curtain. The planar optical waveguide used as a basis in this case can be both plane and cambered and has a multiplicity of decoupling elements, the plate itself having a low absorption coefficient. In this case, the planar optical waveguide has a length, a width and a thickness here: Lₓ, L_{y} and L_{z}. The planar optical waveguide need not, however, necessarily be cuboid or have a rectangular cross section. The decoupling elements are preferably in the shape of a cone or hemisphere. They can, however, also deviate from this shape or have a transitional shape between the two ones named. Also, the cone will not generally have an exactly tipped apex but a rounded one. If they are conical, they preferably have a vertex half-angle β of between 30° and 60°.

The starting point for the exemplary calculation will be a planar optical waveguide of cuboidal shape, with cones as decoupling elements. Nₓ rows of cones are arranged in the Lₓ direction, and there are N_{y} columns in L_{y}, that is to say there is a total of NₓN_{y} comes. The decoupling surface amounts to LₓL_{y}=Aₛ. The light comes from one or more light sources having the total light flux Φ₀ and is propagated chiefly in the x-direction.

If the decoupling element has a base diameter d, it then follows that:

Cross-sectional area for a cone:

$$A = \frac{{d}^{2}}{4 tan β}$$

where β is the vertex half-angle,

and

cross-sectional area for a hemisphere:

$$A = \frac{{d}^{2} \cdot π}{8} .$$

More generally, A=d²·ν, where ν=form factor (generally between 0.1 and 0.5).

The decoupling probability for a beam along the x-direction is then yielded similarly to an effective cross section as:

$$dP \approx {d}^{2} \cdot σ \frac{{N}_{x} {N}_{y}}{{L}_{x} {L}_{y} {L}_{z}} dx .$$

If a beam having N rays is now incident, on average

$$NdP \approx N \cdot {d}^{2} \cdot σ \frac{{N}_{x} {N}_{y}}{{L}_{x} {L}_{y} {L}_{z}} dx$$

rays experience a deflection and exit from the optical waveguide. The number N therein is then reduced in accordance with:

$$dN \approx - N \cdot {d}^{2} \cdot σ \frac{{N}_{x} {N}_{y}}{{L}_{x} {L}_{y} {L}_{z}} dx$$

If the N rays have a light flux of Φ, the light flux decreases correspondingly in the x-direction:

$$Φ \approx {Φ}_{0} \cdot {e}^{\frac{{N}_{x} {N}_{y}}{{L}_{x} {L}_{y} {L}_{z}} {d}^{2} \cdot σ \cdot x}$$

where σ=form factor.

Taking account of the material absorption with an absorption coefficient α, the result for the light flux Φ which exits without being coupled out again from the end face of the optical waveguide (=unused light) is:

for the length Lₓ:

$$Φ \approx {Φ}_{0} \cdot {e}^{\frac{{N}_{x} {N}_{y}}{{L}_{y} {L}_{z}} {d}^{2} \cdot σ} \cdot {e}^{- α \cdot {L}_{x}}$$

where α=form factor

[symbol]

$$Φ \approx {Φ}_{0} \cdot {e}^{\frac{{N}_{x} {N}_{y}}{{A}_{S} \cdot {L}_{y} {L}_{z}} {d}^{2} \cdot σ \cdot {L}_{x}} \cdot {e}^{- α \cdot {L}_{x}}$$

It follows therefrom for the light flux which is decoupled forward that:

$${Φ}_{forward} \approx {Φ}_{0} \cdot ( 1 - {e}^{\frac{{N}_{x} {N}_{y}}{{L}_{y} {L}_{z}} {d}^{2} \cdot σ} \cdot {e}^{- α \cdot {L}_{z}} ) \cdot η ,$$

where η=decoupling factor forward
(the decoupling factor is a function of the decoupling geometry: for example, cone with β=45° is η≈0.4. For hemispheres, η≈0.25).

It holds for the ratio

$$\frac{{d}^{2}}{{A}_{S}}$$

that:

$$\frac{{d}^{2}}{{A}_{S}} \approx \frac{{L}_{x}}{{N}_{x} {N}_{y} {L}_{{x}^{σ}}} ( - α \cdot {L}_{x} - ln ( 1 - \frac{{Φ}_{forward}}{η \cdot {Φ}_{0}} ) )$$

If NₓN_{y} is denoted as Nₜₒₜₐₗ and L_{z} as D_{plate thickness}, and Lₓ as path length through the optical waveguide l, the result is:

$$\frac{{d}^{2}}{{A}_{S}} \approx \frac{{D}_{plate thickness}}{N \cdot l \cdot σ} ( - α \cdot l - ln ( 1 - \frac{{Φ}_{forward}}{η \cdot {Φ}_{0}} ) )$$

$$or$$

$$\frac{{d}^{2}}{{D}_{plate thickness}} \approx ( ( \frac{{A}_{S}}{N \cdot l \cdot σ} - α \cdot l \cdot ln ( 1 - \frac{{Φ}_{forward}}{η \cdot {Φ}_{0}} ) ) .$$

In order now to fulfill a lamp function, the light flux coupled out forward should lie between the minimum and maximum allowed regions:

Φ_{Lamp function}_{_{—}}_{Min}<Φ<Φ_{Lamp function}_{_{—}}_{Max}.

It follows therefrom that:

$$\frac{{D}_{plate thickness}}{N \cdot l \cdot σ} ( - α \cdot l - ln ( 1 - \frac{{Φ}_{Lampfuntion\_Min}}{η \cdot {Φ}_{0}} ) ) < \frac{{d}^{2}}{{A}_{S}} < \frac{{D}_{plate thickness}}{N \cdot l \cdot σ} ( - α \cdot l - ln ( 1 - \frac{{Φ}_{Lampfunction\_Max}}{η \cdot {Φ}_{0}} ) ) .$$

A side light BGL requires at least 4 cd—maximum 60 cd in HV. Given a light distribution similar to a Lambert distribution, this would mean a light flux of approximately 12 lm—approximately 180 lm in the window horizontally and vertically from −90° to 90°. Since the light distribution mostly emerges from the optical waveguide with slightly collimated light, even a relatively low light flux is sufficient to achieve the values, and the result for the extreme values is thus approximately 8 lm—approximately 120 lm in the window horizontally and vertically from −90° to 90°.

$$\begin{matrix}\frac{{D}_{platethickness}}{N \cdot l \cdot σ} ( \begin{matrix}- α \cdot l - \\ ln ( 1 - \frac{8 lm}{η \cdot {Φ}_{0}} )\end{matrix} ) < \frac{{d}^{2}}{{A}_{S}} < \frac{{D}_{platethickness}}{N \cdot l \cdot σ} ( \begin{matrix}- α \cdot l - \\ ln ( 1 - \frac{120 lm}{η \cdot {Φ}_{0}} )\end{matrix} ) & \\ Or \text{:} & \\ \frac{{A}_{S}}{N \cdot l \cdot σ} ( \begin{matrix}- α \cdot l - \\ ln ( 1 - \frac{8 lm}{η \cdot {Φ}_{0}} )\end{matrix} ) < \frac{{d}^{2}}{{D}_{platethickness}} < \frac{{A}_{S}}{N \cdot l \cdot σ} ( \begin{matrix}- α \cdot l - \\ ln ( 1 - \frac{120 lm}{η \cdot {Φ}_{0}} )\end{matrix} ) & \end{matrix}$$

For cones with β=45° half-angle of the vertex (to a first approximation, also cones with 30°<β<60°, the result is therefore:

$$\begin{matrix}\frac{4 {D}_{platethickness}}{N \cdot l} ( - α \cdot l - ln ( 1 - \frac{20 lm}{{Φ}_{0}} ) ) < \frac{{d}^{2}}{{A}_{S}} < \frac{4 {D}_{platethickness}}{N \cdot l} ( - α \cdot l - ln ( 1 - \frac{300 lm}{{Φ}_{0}} ) ) \\ Or \text{:} \\ \frac{4 {A}_{S}}{N \cdot l} ( \begin{matrix}- α \cdot l - \\ ln ( 1 - \frac{20 lm}{{Φ}_{0}} )\end{matrix} ) < \frac{{d}^{2}}{{D}_{platethickness}} < \frac{4 {A}_{S}}{N \cdot l} ( \begin{matrix}- α \cdot l - \\ ln ( 1 - \frac{300 lm}{η \cdot {Φ}_{0}} )\end{matrix} )\end{matrix}$$

Adopting now the following extreme case:

Maximum light flux which can be decoupled:

Only losses owing to Fresnel effects at the entry surface; no absorption (α=0), it follows that:

$$\frac{300 lm}{η \cdot {Φ}_{0}} \to \frac{0.96 \cdot η \cdot {Φ}_{0}}{η \cdot {Φ}_{0}} ⇒ ln ( 0.04 ) \approx - 3$$

$$\frac{4 {A}_{S}}{N \cdot l} ( - α \cdot l - ln ( 1 - \frac{20 lm}{{Φ}_{0}} ) ) < \frac{{d}^{2}}{{D}_{plate thickness}} < \frac{4 {A}_{S}}{N \cdot l} ( 3 ) \text{=} \text{>}$$

$$\frac{4 {A}_{S}}{N \cdot l} ( - α \cdot l - ln ( 1 - \frac{20 lm}{{Φ}_{0}} ) ) < \frac{{d}^{2}}{{D}_{plate thickness}} < \frac{12 {A}_{S}}{N \cdot l}$$

The result for a side light with cones as decoupling elements is therefore an ideal decoupling efficiency when the ratio of

$$\frac{{d}^{2}}{{D}_{plate thickness}}$$

lies in the interval from

$$\frac{4 {A}_{S}}{N \cdot l} ( - α \cdot l - ln ( 1 - \frac{20 lm}{{Φ}_{0}} ) ) to \frac{12 {A}_{S}}{N \cdot l} .$$

For hemispheres with η≈0.25, an ideal decoupling efficiency results whenever

$$\frac{{d}^{2}}{{D}_{plate thickness}}$$

lies in the interval from

$$\frac{4 {A}_{S}}{N \cdot l} ( - α \cdot l - ln ( 1 - \frac{32 lm}{{Φ}_{0}} ) ) to \frac{12 {A}_{S}}{N \cdot l} .$$

Since cones constitute the most efficient form of decoupling, it may also be said in general that: the ratio of

$$\frac{{d}^{2}}{{D}_{plate thickness}}$$

must lie in the interval from

$$\frac{4 {A}_{S}}{N \cdot l} ( - α \cdot l - ln ( 1 - \frac{20 lm}{{Φ}_{0}} ) ) to \frac{12 {A}_{S}}{N \cdot l} ,$$

or the ratio of

$$\frac{{d}^{2}}{{D}_{plate thickness}}$$

must lie in the interval from

$$\frac{4 {A}_{S}}{N \cdot l} ( - α \cdot l - ln ( 1 - \frac{2.5 \cdot {Φ}_{Minimum of lamp function}}{{Φ}_{0}} ) ) to \frac{12 {A}_{S}}{N \cdot l} ,$$

where

Φ_{Minimum of lamp function}>8 lm for side light R7
>8 lm for tail light R7
>8 lm for side marker
>800 lm for daytime running light
>350 lm BLL R6 cat 1
>500 lm BLL R6 cat 1a
>800 lm BLL R6 cat 1b
>100 lm BLL R6 cat 2a
>120 lm brake light R7
>700 lm rear fog light R38

The light decoupling can therefore be optimized in the above way by means of a flat or planar optical waveguide.

The aim below is to explain the invention in more detail with the aid of a drawing, in which:

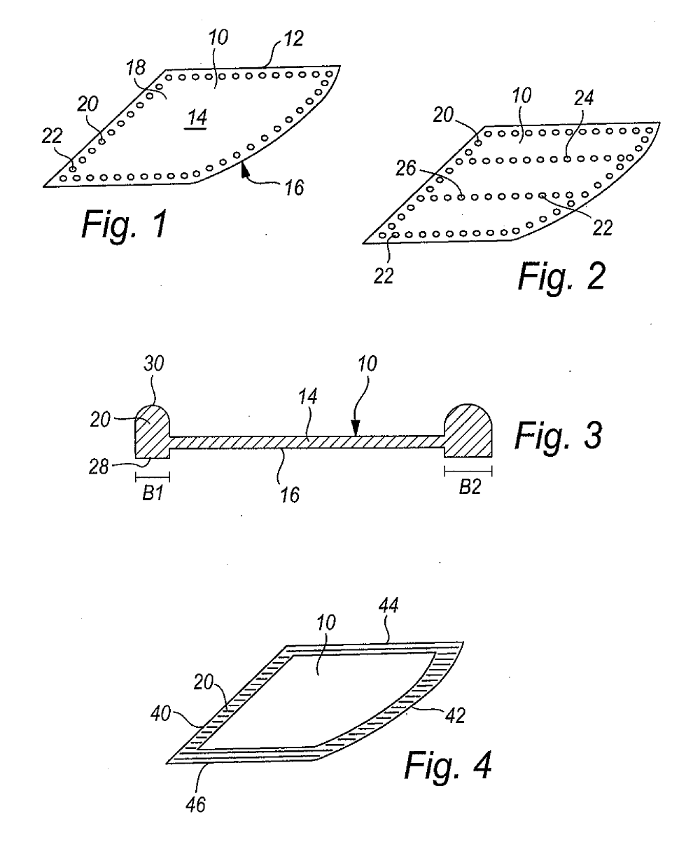

FIG. 1 shows a first refinement of the invention,

FIG. 2 shows an alternative refinement of the invention,

FIG. 3 shows a section through FIG. 1,

FIG. 4 shows a further refinement of the invention,

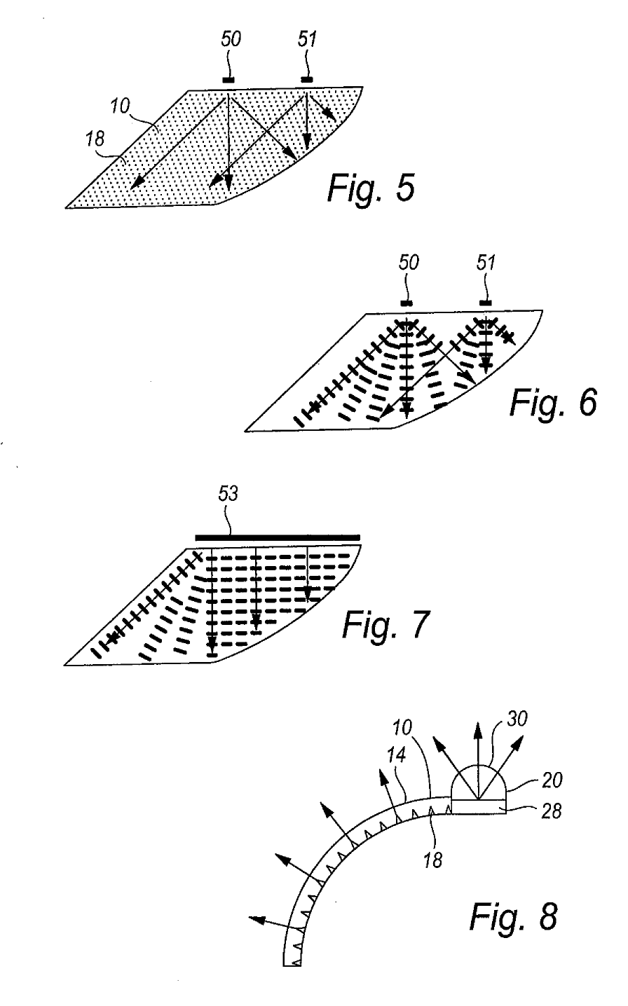

FIG. 5 shows a planar optical waveguide with small decoupling structures,

FIG. 6 shows a further planar optical waveguide,

FIG. 7 shows a third refinement of a planar optical waveguide, and

FIG. 8 shows a further embodiment of the invention.

Here, FIG. 1 shows a lamp arrangement comprising a planar optical waveguide 10 with a peripheral surface 12 and two optical waveguide surfaces 14, 16, the optical waveguide surface 14 being designed as light decoupling surface, and the opposite side 16 having decoupling elements. The peripheral surface 12 serves in this case for coupling light in from a light source (not illustrated). Here, the decoupling elements are designed as small (light) decoupling elements as elevations or depressions in the surface 16 and are denoted by the reference numeral 18.

In addition to the planar optical waveguide 10, the lamp comprises a rod-like optical waveguide 20 which is connected in one piece to the planar optical waveguide 10, and extends over the entire periphery of the planar optical waveguide 10. Conical (light) decoupling elements 22 are provided in the rod-like optical waveguide 20, which likewise has a light decoupling surface and a surface which is opposite the light decoupling surface and supports the second decoupling elements, the light exit direction for the planar optical waveguide 10 and for the rod-like optical waveguide 20 being identical or substantially the same.

In this case, the light decoupling elements 22 are dimensioned with regard to their measurements, that is to say their base surface and their height, such that they produce a light distribution, in particular a side light, a contour illumination or an active side marker.

The decoupling elements 18 of the planar optical waveguide 10 are of clearly smaller configuration and deflect the light such that it produces as homogeneous as possible a light distribution for the purpose of ambient illumination. A lighting function for the purpose of a function defined by statute is not achieved hereby, but rather the light intensity produced remains below the provisions permissible by statute.

FIG. 2 shows an alternative refinement in the case of which there are provided in addition to the rod-like optical waveguide 20, which extends along the periphery of the planar optical waveguide 10, two further rod-like optical waveguides 24 and 26 which extend in transverse fashion through the planar optical waveguide 10, the light decoupling elements, which are likewise denoted here by the reference numeral 22, corresponding to those of the planar optical waveguide 10 in shape and dimensions. Yet further optical effects can be attained in this way.

Finally, FIG. 3 shows a section through an optical waveguide in accordance with FIG. 1 with a light decoupling surface 14 of the planar optical waveguide 10 and an opposite side 16 on which the decoupling elements are arranged. In the region of the rod-like optical waveguide 20, the decoupling elements 22 (not illustrated in this case) are likewise arranged on the surface 28, and the light leaves the optical waveguide 20 through a light decoupling surface 30 which is opposite the surface 28, which supports the decoupling elements 22. The light emission direction of the planar optical waveguide 10 and of the rod-like optical waveguide 20 is therefore substantially the same.

It can likewise be provided here that the width B1 or B2 of the rod-like optical waveguide can be of varying design along its length.

FIG. 4 shows an alternative refinement, although identical elements are denoted by identical reference numerals. The planar optical waveguide 10 is hereby configured as in FIG. 1. A rod-like optical waveguide 20 extends along the planar optical waveguide 10, around the circumference thereof, the prisms here not, as in the case of the refinement in accordance with FIG. 1 and FIG. 2, being arranged as individual conical decoupling elements, but as prisms or roof-shaped elements, the prisms being arranged at the sides 40 and 42 in a fashion transverse to the longitudinal direction of the rod-like optical waveguide 20, and running at the sides 44 and 46 in a longitudinal direction such that there is arranged at the sides 44 and 46 a single long prism which extends over the entire length of the rod-like optical waveguide 20. It is possible hereby to implement particular optical and lighting effects, especially as all the prism surfaces run parallel to one another.

FIG. 5 shows an embodiment in which the aim is to explain in more detail the possibility of controlling the light distribution to be attained and homogeneity. FIG. 5 firstly shows a refinement with small conical decoupling prisms of the planar optical waveguide 10, as also illustrated in FIG. 1. Furthermore, two light sources 50 and 51 are illustrated here which couple the light into the planar optical waveguide 10. The rod-like optical waveguide 20 is not shown in FIGS. 5-7 for reasons of clarity. In the case of punctiform light sources 50 and 51, the light is distributed as indicated by the light rays illustrated, substantially in a radial direction. In the case of light sources such as the light source 53 in FIG. 7, which illustrates an elongated or linear light source, the result is essentially a linear propagation of the light except in the edge region of the light source. The propagation is again in the form of a beam there (radial). By adapting the decoupling elements, as is now undertaken in FIG. 6, in such a way that said decoupling elements are aligned in relation to the light distribution with their deflecting surfaces, it is now possible to produce a particularly homogeneous light distribution by comparison with the small decoupling structures 18 as shown in FIG. 5. In this case, decoupling elements with flat surfaces yield a more directable deflection than ones with curved deflecting surfaces.

By means of the selection and alignment of the decoupling elements, for example by using roof-like decoupling elements which are aligned in accordance with the radial light alignment from the light sources 50 and 51, as in FIG. 6, or in a linear direction and radial direction, as by the light source 53 in FIG. 7, it is possible to achieve a particularly homogeneous light propagation with a clearly higher decoupling efficiency in a specific direction, since the proportion of the light scattered to the side is substantially smaller than in the case of rotationally symmetrical decoupling elements such as, for example, hemispheres or cones, as shown in FIG. 5.

Finally, FIG. 8 shows an embodiment with a curved planar optical waveguide 10 in section, being arranged opposite the decoupling side 14 decoupling elements 18 which couple out light in a direction perpendicular to the light decoupling surface 14. In this case, the planar optical waveguide 10 is connected by integral bonding to a rod-like optical waveguide 20 along a portion of its periphery, the rod-like optical waveguide 20 decoupling light substantially in the direction in front of a motor vehicle, the rod-like optical waveguide having for this purpose second light decoupling elements which are arranged on the side 28, opposite the decoupling surface 30, of the rod-like optical waveguide.

It is possible to provide in the way described above a lamp which, in addition to interesting design aspects, is capable of providing a light function in a desired matter and improves the visibility of a vehicle.

1. A lamp for a motor vehicle having at least one light source and at least one planar optical waveguide with at least two optical waveguide surfaces and at least one peripheral surface into which the light of the light source can be coupled directly or indirectly, and a light decoupling surface that is formed by one of the optical waveguide surfaces, first decoupling elements being provided on the optical waveguide surface opposite the light decoupling surface, wherein at least one rod-like optical waveguide is provided which is connected directly to the planar optical waveguide or is part of the planar optical waveguide the rod-like optical waveguide having a decoupling surface that decouples substantially into or against a driving direction of the motor vehicle and the light decoupling direction of the planar optical waveguide is substantially perpendicular to at least one of its optical waveguide surfaces, and it being possible for the light of a light source to be coupled directly or indirectly into the rod-like optical waveguide, and the rod-like optical waveguide having second light decoupling elements that are arranged on that side of the rod-like optical waveguide that is opposite the decoupling surface.

2. The lamp as claimed in claim 1, wherein the dimensions of the first light decoupling elements are such that the incident light is scattered such that no statutory light function is fulfilled by the planar optical waveguide, and the second light decoupling elements are dimensioned such that the incident light is scattered and decoupled such that a statutory light function is fulfilled.

3. The lamp as claimed in claim 1, wherein the first light decoupling elements have a greatest extent in the plane direction of less than 5 mm, in particular of less than 1 mm, and in particular of less than 0.5 mm.

4. The lamp as claimed in claim 2, wherein the second light decoupling elements have a greatest extent in the plane direction of greater than 0.5 mm, in particular of greater than 1 mm, and in particular of greater than 5 mm.

5. The lamp as claimed in claim 1, wherein the second light decoupling elements are prisms whose deflecting surfaces are arranged transverse to the longitudinal extent of the rod-like optical waveguide.

6. The lamp as claimed in claim 1, wherein the second light decoupling elements are prisms whose deflecting surfaces are arranged parallel to the longitudinal extent of the rod-like optical waveguide.

7. The lamp as claimed in claim 1, wherein the first light decoupling elements are formed by prisms, cones, spherical caps, recesses and/or surface roughnesses, and/or scattering elements, in particular filters, in the optical waveguide.

8. The lamp as claimed in claim 1, wherein the rod-like optical waveguide extends over at least a portion of the periphery of the planar optical waveguide.

9. The lamp as claimed in claim 1, wherein the planar optical waveguide extends only over a portion of the rod-like optical waveguide.

10. The lamp as claimed in claim 1, wherein the rod-like optical waveguide is arranged in the planar optical waveguide.

11. The lamp as claimed in claim 1, wherein the two optical waveguides are interconnected in one piece or by integral bonding.

12. The lamp as claimed in claim 1, wherein the rod-like optical waveguide has a greater extent in the light emission direction than the planar.

13. The lamp as claimed in claim 1, wherein a further lamp is arranged behind the planar optical waveguide against the light emission direction.

14. The lamp as claimed in claim 1, wherein the coupling surfaces are one or more sections of the peripheral surface of the planar optical waveguide.

15. The lamp as claimed in claim 1, wherein the light coupling surface of at least one rod-like optical waveguide is formed by at least one of its end faces.

16. The lamp as claimed in claim 1, wherein the optical waveguides have a common light source.

17. The lamp as claimed in claim 1, wherein the homogeneity can be influenced by varying the parameters of the light decoupling elements.
